(19) United States
(12) Patent Application Publication
(10) Pub. No.: US 2026/0086720 A1
(43) Pub. Date: Mar. 26, 2026

(54) POWERING DOWN MEMORY DEVICE BASED ON DISABLING BACKGROUND OPERATION ASSOCIATED WITH MEMORY DEVICE

(71) Applicant: QUALCOMM Incorporated, San Diego, CA (US)

(72) Inventors: Manish PANDEY, Bhopal (IN); Nitin RAWAT, Gumla (IN); Naveen Kumar Goud AREPALLI, Hyderabad (IN); Santhosh Reddy AKAVARAM, Hyderabad (IN); Sang TRAN, Encinitas, CA (US)

(21) Appl. No.: 18/896,019

(22) Filed: Sep. 25, 2024

(51) Int. Cl. G06F 3/06

(52) U.S. Cl. CPC G06F 3/0616; G06F 3/0634; G06F 3/0679

(57) ABSTRACT

Various aspects of the present disclosure generally relate to memory devices. In some aspects, a host device may detect a background operation status associated with a memory device. The host device may transmit, to the memory device and based at least in part on the background operation status, a command to disable a background operation associated with the memory device. The host device may transmit, to the memory device, a power down command in accordance with a timeout associated with the background operation. The host device may receive, from the memory device, a response. The host device may instruct, based at least in part on the response, one or more resources associated with the memory device to enter into a low power mode state or an off state. Numerous other aspects are described.

### FIELD OF DISCLOSURE

Aspects of the present disclosure generally relate to memory devices and, for example, to powering down a memory device based at least in part on disabling a background operation associated with the memory device.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### SUMMARY

In some implementations, a host device includes one or more components configured to: detect a background operation status associated with a memory device; transmit, to the memory device and based at least in part on the background operation status, a command to disable a background operation associated with the memory device; transmit, to the memory device, a power down command in accordance with a timeout associated with the background operation; receive, from the memory device, a response; and instruct, based at least in part on the response, one or more resources associated with the memory device to enter into a low power mode state or an off state.

In some implementations, a memory device includes one or more components configured to: receive, from a host device, a command to disable a background operation associated with the memory device; disable the background operation based at least in part on the command; receive, from the host device, a power down command in accordance with a timeout associated with the background operation; transmit, to the host device, a response to acknowledge the power down command; and enter, after the response is transmitted, a low power mode state or an off state for one or more resources associated with the memory device.

In some implementations, a method includes detecting, by a host device, a background operation status associated with a memory device; transmitting, from the host device to the memory device and based at least in part on the background operation status, a command to disable a background operation associated with the memory device; transmitting, from the host device to the memory device, a power down command in accordance with a timeout associated with the background operation; receiving, by the host device and from the memory device, a response; and instructing, by the host device and based at least in part on the response, one or more resources associated with the memory device to enter into a low power mode state or an off state.

In some implementations, a method includes receiving, by a memory device and from a host device, a command to disable a background operation associated with the memory device; disabling, by the memory device, the background operation based at least in part on the command; receiving, by the memory device and from the host device, a power down command in accordance with a timeout associated with the background operation; transmitting, from the memory device to the host device, a response to acknowledge the power down command; and entering, by the memory device and after the response is transmitted, a low power mode state or an off state for one or more resources associated with the memory device.

In some implementations, a non-transitory computer-readable medium storing a set of instructions for wireless communication includes one or more instructions that, when executed by one or more processors of a host device, cause the host device to: detect a background operation status associated with a memory device; transmit, from the host device to the memory device and based at least in part on the background operation status, a command to disable a background operation associated with the memory device; transmit, from the host device to the memory device, a power down command in accordance with a timeout associated with the background operation; receive, from the memory device, a response; and instruct, based at least in part on the response, one or more resources associated with the memory device to enter into a low power mode state or an off state.

In some implementations, a non-transitory computer-readable medium storing a set of instructions for wireless communication includes one or more instructions that, when executed by one or more processors of a memory device, cause the memory device to: receive, from a host device, a command to disable a background operation associated with the memory device; disable the background operation based at least in part on the command; receive, from the host device, a power down command in accordance with a timeout associated with the background operation; transmit, from the memory device to the host device, a response to acknowledge the power down command; and enter, after the response is transmitted, a low power mode state or an off state for one or more resources associated with the memory device.

In some implementations, an apparatus for wireless communication includes means for detecting a background operation status associated with a memory device; means for transmitting, from the apparatus to the memory device and based at least in part on the background operation status, a command to disable a background operation associated with the memory device; means for transmitting, from the apparatus to the memory device, a power down command in accordance with a timeout associated with the background operation; means for receiving, from the memory device, a response; and means for instructing, based at least in part on the response, one or more resources associated with the memory device to enter into a low power mode state or an off state.

In some implementations, an apparatus for wireless communication includes means for receiving, from a host device, a command to disable a background operation associated with the apparatus; means for disabling the background operation based at least in part on the command; means for receiving, from the host device, a power down command in accordance with a timeout associated with the background operation; means for transmitting, from the apparatus to the host device, a response to acknowledge the power down command; and means for entering, after the response is transmitted, a low power mode state or an off state for one or more resources associated with the memory device.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example associated with universal flash storage (UFS), in accordance with the present disclosure.

FIG. 2 is a diagram illustrating an example associated with a power mode state machine, in accordance with the present disclosure.

FIG. 3 is a diagram of an example associated with powering down a memory device, in accordance with the present disclosure.

FIGS. 4-5 are diagrams of examples associated with powering down a memory device based at least in part on disabling a background operation associated with the memory device, in accordance with the present disclosure.

FIG. 6 is a diagram illustrating example components of a device, in accordance with the present disclosure.

FIGS. 7-8 are flowcharts of example processes associated with powering down a memory device based at least in part on disabling a background operation associated with the memory device, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Universal flash storage (UFS) is a specification for non-volatile memory. UFS was developed by the Joint Electron Device Engineering Council (JEDEC) solid state technology association. UFS may be utilized in a variety of electronic devices, such as smart phones, tablets, and digital cameras. UFS may offer a high-performance and efficient storage solution. UFS may provide high-speed data transfer capabilities, which may be useful for high-resolution video recording, fast application loading, and/or quick data transfers. UFS may support simultaneous read and write operations, known as full duplex, which may enhance a multitasking performance. UFS may be power-efficient, which is crucial for mobile devices. UFS may utilize a command queue, which may allow for multiple commands to be processed in parallel, which may improve overall efficiency and performance. The command queue may reduce power usage during data processing.

A host device, such as a UFS host, may determine to place a memory device, such as a UFS device, into a low power mode (e.g., a pre-deep-sleep power mode or a UFS deep sleep power mode). After the host device determines to place the memory device into the low power mode, the host device may issue a command to the memory device. The memory device may transmit a response to the host device based at least in part on the command. After receiving the response from the memory device, the host device may place UFS resources (e.g., rails, clocks, and/or other resources) into a low power mode state or an off state, irrespective of a current device state associated with the memory device. However, the memory device may still draw power that is beyond a permissive low power mode current threshold for a period of time (e.g., a few milliseconds) to complete device side operations. The memory device may draw the power that is beyond the permissive low power mode current threshold even after the host device places the UFS resources in the low power mode state or the off state. In other words, after sending the response, the memory device may need the period of time to complete the device side operations, and the memory device may not be able to complete the device side operations before the host device places the UFS resources in the low power mode state. The period of time may vary depending on an age or operations on the device side.

As a result of the continued operations at the memory device for the period of time, the memory device may experience an overcurrent protection fault from hardware, which may result in a crash or error for the memory device. The memory device may experience an overcurrent because the UFS resources may be utilized for the device side operations after the UFS resources are placed in the low power mode state or the off state, where the use of the UFS resources (e.g., a voltage/current consumed using the UFS resources) may exceed the permissive low power mode current threshold. The memory device may become corrupted based at least in part on the overcurrent, and a recovery may impact a boot time associated with the memory device (e.g., a boot up when the memory device wakes up from the low power mode).

Various aspects relate generally to memory devices. Some aspects more specifically relate to UFS-based memory devices. In some examples, a host device may detect a background operation status associated with a memory device. The host device may transmit, to the memory device and based at least in part on the background operation status, a command to disable a background operation associated with the memory device. The memory device may disable the background operation based at least in part on the command. The memory device may disable the background operation prior to transmitting a response to protect against overcurrent at the memory device. The host device may transmit, to the memory device, a power down command in accordance with a timeout associated with the background operation. The host device may transmit the power down command after waiting for the timeout associated with the background operation. The host device may receive, from the memory device, the response. The host device may instruct, based at least in part on the power down command and the response, one or more resources associated with the memory device to enter into a low power mode state or an off state. During the low power mode state or the off state, an amount of current used by the one or more resources is not to exceed a certain threshold. The memory device may enter, after the response is transmitted, the low power mode state or the off state for one or more resources associated with the memory device.

Particular aspects of the subject matter described in this disclosure can be implemented to realize one or more of the following potential advantages. In some examples, by powering down a memory device based at least in part on disabling a background operation associated with the memory device, the described techniques can be used to achieve overcurrent protection at memory devices. The host device may detect whether any background operations are present at the memory device, and when one or more background operations are detected to be present at the memory device, the host device may send the command to disable the one or more background operations. The host device may wait for the one or more background operations to timeout. In other words, the host device may wait a certain period of time, after which the one or more background operations will be no longer running. The host device may transmit the power down command only after the timeout of the one or more background operations. As a result, after the one or more resources enter the low power mode state or the off state, the memory device may not draw an amount of current (e.g., from background operations) that exceeds the certain threshold, which would otherwise cause an overcurrent to occur at the memory device and lead to device failure. By powering down the memory device after disabling the background operation, the memory device may achieve overcurrent protection, thereby enhancing a UFS memory device power mode state machine and improving an overall performance.

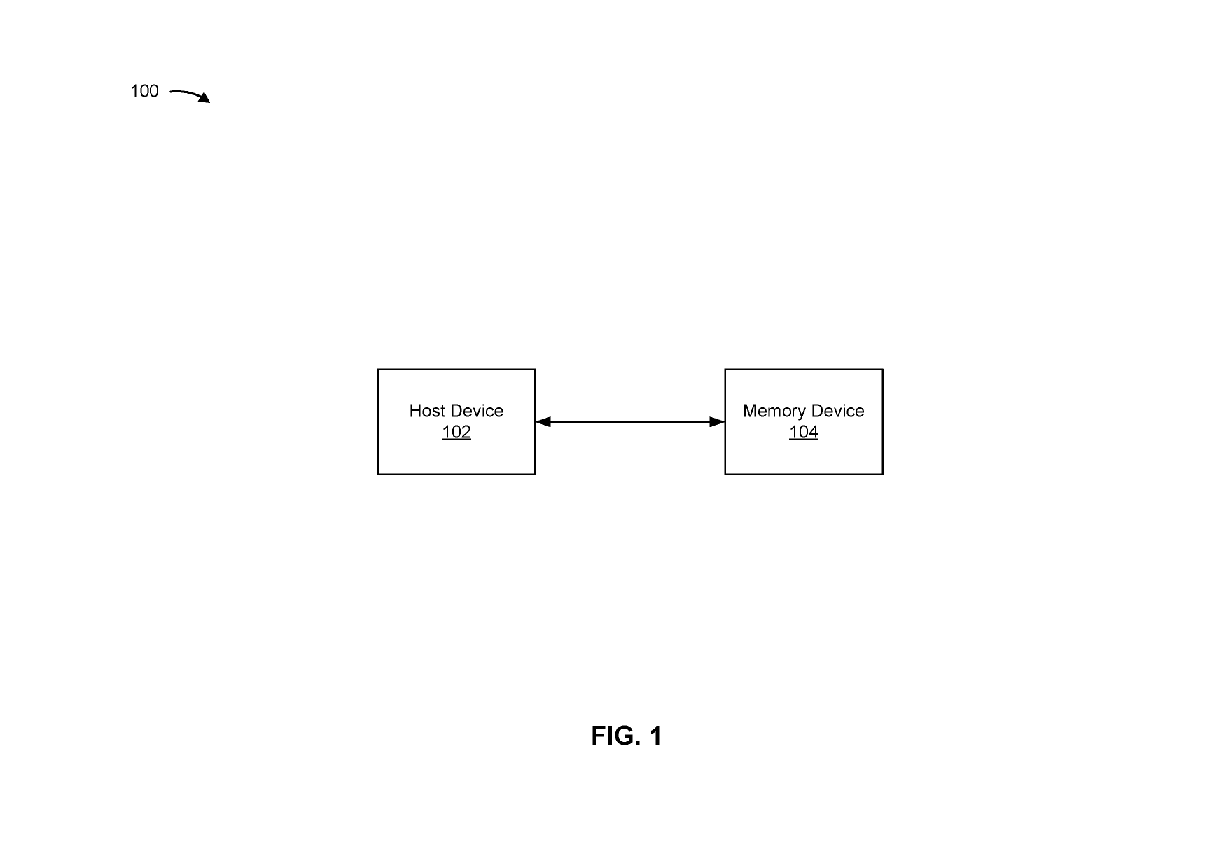

FIG. 1 is a diagram illustrating an example 100 associated with UFS, in accordance with the present disclosure.

As shown in FIG. 1, a host device 102, such as a UFS host, may communicate with a memory device 104, such as a UFS device. The host device 102 may be associated with an application processor or a system on chip (SoC), for example, in a mobile device. The memory device 104 may include a controller and non-volatile memory, such as flash memory. The host device 102 may communicate with the memory device 104 via an interconnect. The interconnect may utilize a high-speed interface to allow for rapid data transfer between the host device 102 and the memory device 104.

As indicated above, FIG. 1 is provided as an example. Other examples may differ from what is described with regard to FIG. 1.

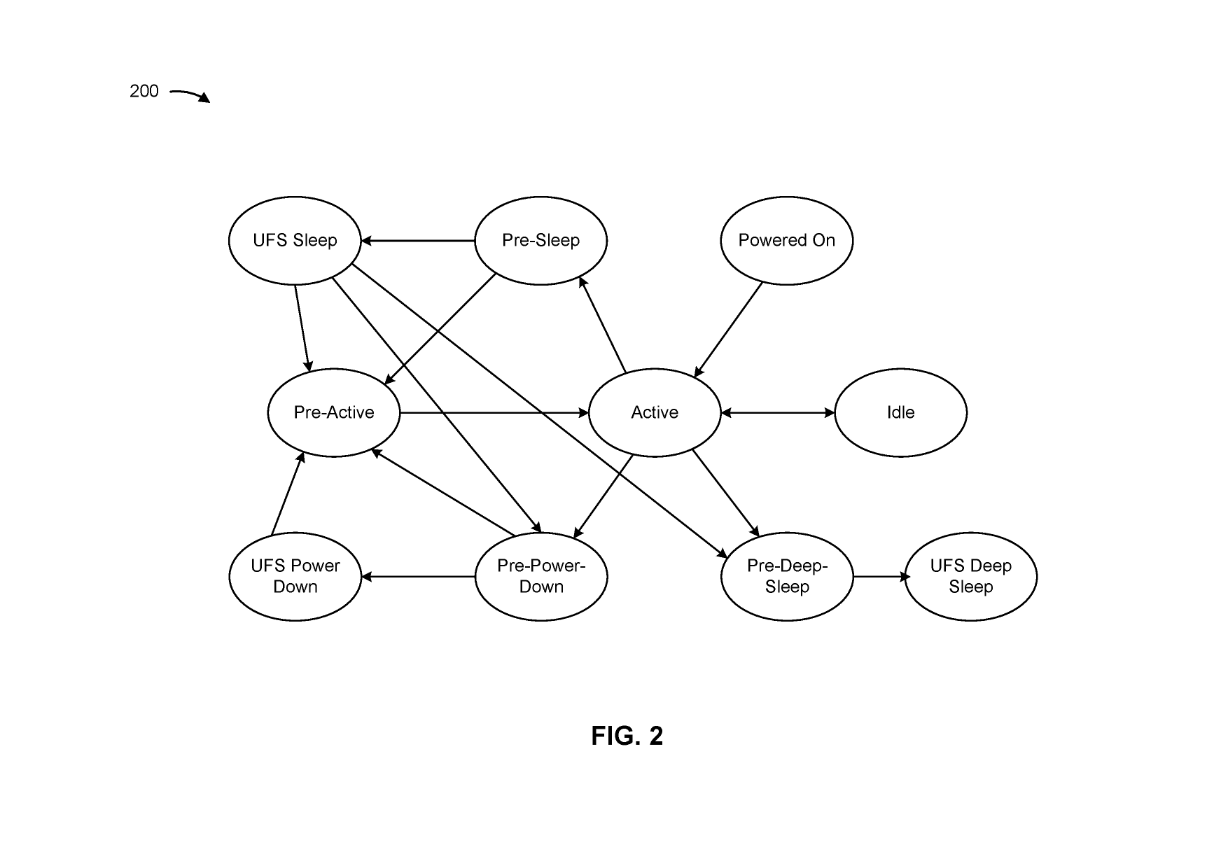

FIG. 2 is a diagram illustrating an example 200 associated with a power mode state machine, in accordance with the present disclosure.

As shown in FIG. 2, a UFS system may be associated with a power mode state machine. The power mode state machine may define relationships between various power modes. The power modes may include a powered on mode, an idle mode, an active mode, a pre-active mode, a pre-sleep mode, a UFS sleep mode, a pre-power-down mode, a UFS power down mode, a pre-deep-sleep mode, and/or a UFS deep sleep mode.

As indicated above, FIG. 2 is provided as an example. Other examples may differ from what is described with regard to FIG. 2.

A UFS power down power mode may be used prior to completely powering off a memory device, such as a UFS device. All volatile data may be lost, and a voltage or all power supplies may be removed. The UFS power down power mode may be automatically entered from a pre-power-down power mode at a completion of a power mode transition.

A UFS deep sleep power mode may be used to achieve a low power consumption of the memory device. A power supply may be turned off when the memory device is in the UFS deep sleep power mode. The UFS deep sleep power mode may be entered from a pre-deep-sleep power mode. While in the UFS deep sleep power mode, the memory device may not respond to any commands from a host device, such as a UFS host device. During the UFS deep sleep power mode, the memory device may place an interface, such as an M-PHY interface, in an unpowered state to minimize power consumption. The host device may be expected to request a transition to the UFS deep sleep power mode only when no pending task requests or task management requests are present. A start stop unit (SSU) command may be used to request a transition from the pre-deep-sleep power mode to the UFS deep sleep power mode. The memory device may respond to the SSU command when the memory device is ready to transition from the pre-deep-sleep power mode to the UFS deep sleep power mode. No further commands may be accepted during the pre-deep-sleep power mode and the UFS deep sleep power mode. The UFS deep sleep power mode may be exited using a hardware reset or a power cycle. The host device may wake up the memory device by using the hardware reset or the power cycle. After the hardware reset or the power cycle, a UFS power mode may return to the UFS sleep mode or the active mode.

The SSU command may be one type of power management command. The SSU command may be sent to a logical unit in order to enable or disable that logical unit, flush all cached logical blocks to a medium (for logical units that contain a cache), and/or load or eject the medium. The SSU command may be sent to a logical unit in the memory device to select a device power mode.

After the host device determines to place the memory device into a low power mode (e.g., the pre-deep-sleep power mode or the UFS deep sleep power mode), the host device may issue the SSU command to the memory device. The SSU command may indicate a power condition (PC), such as PC=3 or PC=4. The memory device may respond to the host device based at least in part on the SSU command. For example, the memory device may respond with an acknowledgement (ACK) to the host device. After receiving the ACK from the memory device, the host device may place UFS resources (e.g., rails, clocks, and/or other resources) to a low power mode state or an off state, irrespective of a current device state associated with the memory device. However, the memory device may still draw power that is beyond a permissive low power mode current threshold for a period of time (e.g., a few milliseconds) to complete device side operations. The memory device may draw the power that is beyond the permissive low power mode current threshold even after the host device places the UFS resources in the low power mode state or the off state. In other words, after sending the ACK, the memory device may need the period of time to complete the device side operations, and the memory device may not be able to complete the device side operations before the host device places the UFS resources in the low power mode state. The period of time may vary depending on an age or operations on the device side.

As a result of the continued operations at the memory device for the period of time, the memory device may experience an overcurrent protection fault from hardware, which may result in a crash or error for the memory device. The memory device may experience an overcurrent because the UFS resources may be utilized for the device side operations after the UFS resources are placed in the low power mode state or the off state, where the use of the UFS resources (e.g., a voltage/current consumed using the UFS resources) may exceed the permissive low power mode current threshold. The memory device may become corrupted based at least in part on the overcurrent, and a recovery may impact a boot time associated with the memory device (e.g., a boot up when the memory device wakes up from the low power mode).

In some cases, the host device may implement a delay before placing the UFS resources in the low power mode state or the off state. For example, the host device, by default, may wait for a period of time (e.g., 2 milliseconds) after receiving the ACK from the memory device, and then the host device may place the UFS resources in the low power mode state or the off state. The delay may provide the memory device with a period of time to finish the device side operations. However, the delay may be fixed (e.g., a predefined delay), even though the amount of time needed to finish the device side operations may vary depending on the age or type of operation, and the amount of time needed to finish the device side operations may vary from vendor to vendor. In some cases, the delay may be insufficient and device side operations may still be ongoing after the UFS resources are placed in the low power mode state or the off state. In other cases, the delay may be overly long, which may increase power consumption at the memory device because the memory device may wait to enter the low power mode state. As a result, an overall system performance may be degraded.

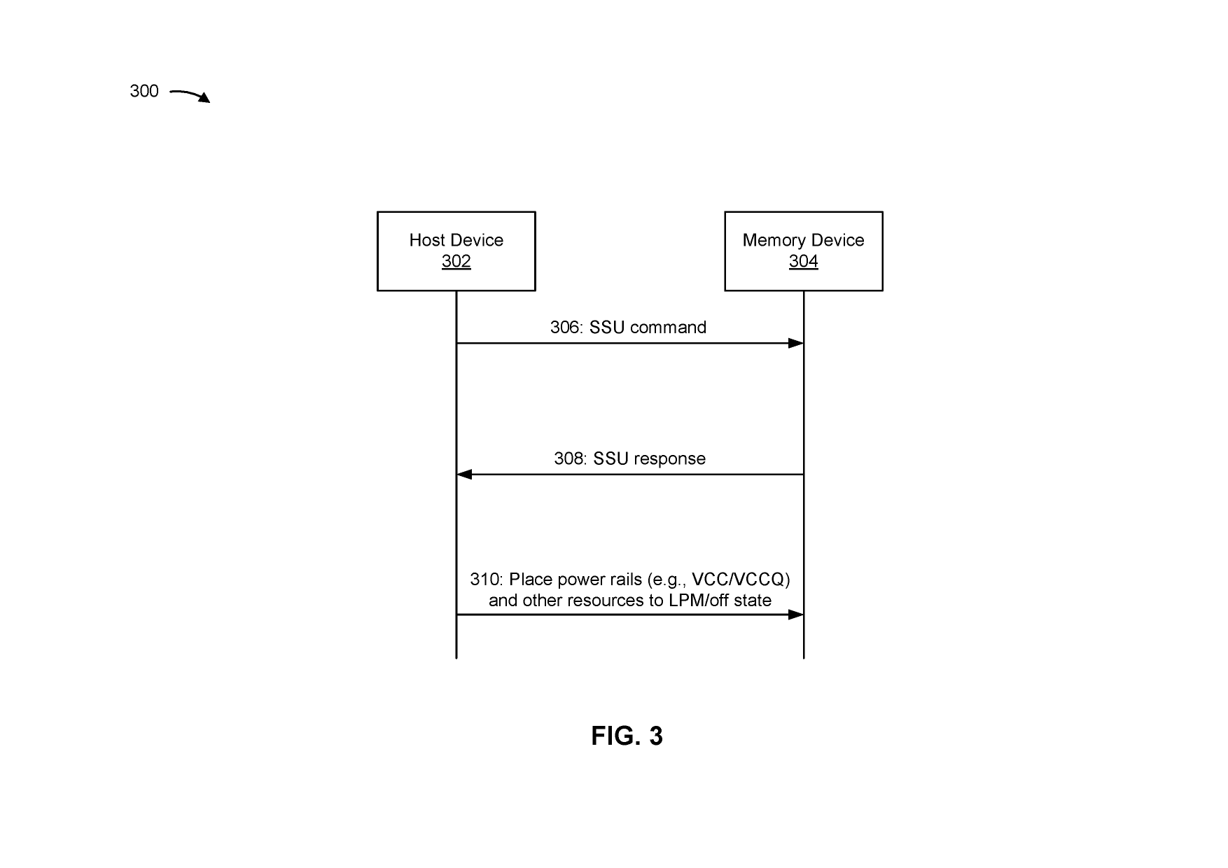

FIG. 3 is a diagram illustrating an example 300 associated with powering down a memory device, in accordance with the present disclosure. As shown in FIG. 3, example 300 includes communication between a host device 302, such as a UFS host, and a memory device 304, such as a UFS device.

As shown by reference number 306, the host device 302 may transmit an SSU command (e.g., PC=3 or PC=4) to the memory device 304. The SSU command may be to enable a device power mode. The host device 302 may transmit the SSU command to instruct the memory device 304 to enter into the device power mode. The SSU command may be a power down command. As shown by reference number 308, the memory device 304 may transmit an SSU response to the host device 302. The SSU response may be an ACK. As shown by reference number 310, after receiving the SSU response, the host device 302 may place power rails (e.g., a voltage at collector (VCC) power rail) associated with the memory device 304 and other resources associated with the memory device 304 into a low power mode state or an off state.

After receiving the SSU response, the host device 302 may change a regulator to the low power mode state or the off state along with other resources. After receiving the SSU response, the host device 302 may not check a UFS memory device state, and irrespective of whether the memory device 304 is powered off or not, the UFS host device 302 may set the regulator to the low power mode state or the off state. When the memory device 304 is still operational and performing some background operations or preparing for powering off, the memory device 304 may continue to draw an amount of current. When the amount of current exceeds a permissive low power mode current threshold, the memory device 304 may be subjected to overcurrent, which may result in a hardware fault and/or the memory device 304 entering a bad/error state.

As indicated above, FIG. 3 is provided as an example. Other examples may differ from what is described with regard to FIG. 3.

In various aspects of techniques and apparatuses described herein, a host device may detect a background operation status associated with a memory device. The host device may transmit, to the memory device and based at least in part on the background operation status, a command to disable a background operation associated with the memory device. The memory device may disable the background operation based at least in part on the command. The memory device may disable the background operation prior to transmitting a response to protect against overcurrent at the memory device. The host device may transmit, to the memory device, a power down command in accordance with a timeout associated with the background operation. The host device may transmit the power down command after waiting for the timeout associated with the background operation. The host device may receive, from the memory device, the response. The host device may instruct, based at least in part on the power down command and the response, one or more resources associated with the memory device to enter into a low power mode state or an off state. During the low power mode state or the off state, an amount of current used by the one or more resources is not to exceed a certain threshold. The memory device may enter, after the response is transmitted, the low power mode state or the off state for one or more resources associated with the memory device.

In some aspects, by powering down a memory device based at least in part on disabling a background operation associated with the memory device, overcurrent protection may be achieved at memory devices. The host device may detect whether any background operations are present at the memory device, and when one or more background operations are detected to be present at the memory device, the host device may send the command to disable the one or more background operations. The host device may wait for the one or more background operations to timeout. In other words, the host device may wait a certain period of time, after which the one or more background operations will be no longer running. The host device may transmit the power down command only after the timeout of the one or more background operations. As a result, after the one or more resources enter the low power mode state or the off state, the memory device may not draw an amount of current (e.g., from background operations) that exceeds the certain threshold, which would otherwise cause an overcurrent to occur at the memory device and lead to device failure. By powering down the memory device after disabling the background operation, the memory device may achieve overcurrent protection, thereby enhancing a UFS memory device power mode state machine and improving an overall performance.

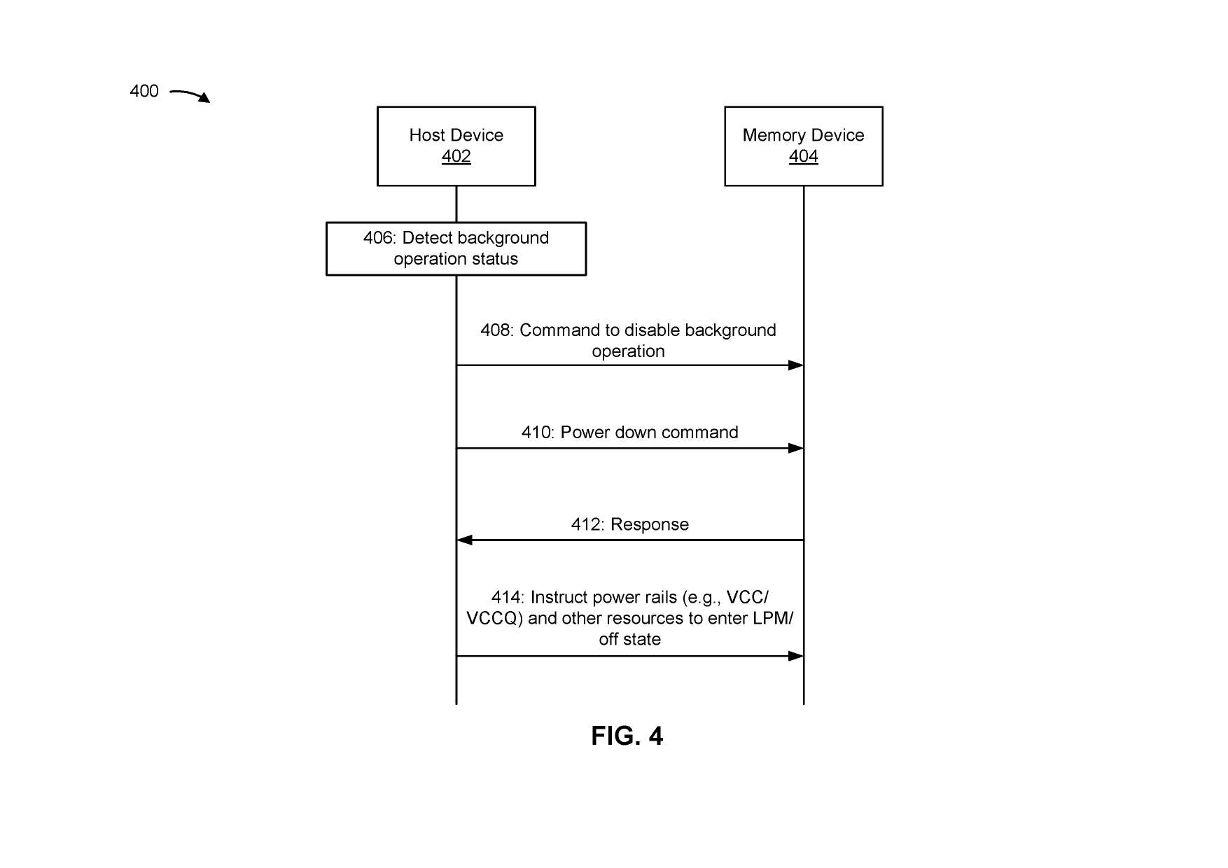

FIG. 4 is a diagram illustrating an example 400 associated with powering down a memory device based at least in part on disabling a background operation associated with the memory device, in accordance with the present disclosure. As shown in FIG. 4, example 400 includes communication between a host device 402, such as a UFS host, and a memory device 404, such as a UFS device. The memory device 404 may be a non-volatile memory device.

As shown by reference number 406, the host device 402 may detect a background operation status associated with the memory device 404. The background operation status may indicate whether any background operations are ongoing or currently running at the memory device 404. In some aspects, the host device 402 may maintain a register of ongoing background operations being run at the memory device 404, in which case the host device 402 may check the register in order to determine the background operation status. Additionally, or alternatively, the host device 402 may query the memory device 404. For example, the host device 402 may send, to the memory device 404, a query as to whether any background operations are ongoing or currently running at the memory device 404. The memory device 404 may respond to the query, which may enable the host device 402 to determine the background operation status.

As shown by reference number 408, the host device 402 may transmit, to the memory device 404 and based at least in part on the background operation status, a command, such as a query command, to disable a background operation associated with the memory device 404. The host device 402 may transmit the command when the background operation status indicates an ongoing background operation at the memory device 404. The memory device 404 may receive the command and disable the background operation based at least in part on the command.

As shown by reference number 410, the host device 402 may transmit, to the memory device 404, a power down command in accordance with a timeout associated with the background operation. The host device 402 may transmit the power down command after waiting for the timeout associated with the background operation. An amount of time for the timeout may depending on the background operation. For example, certain types of background operations may be associated with longer timeouts in relation to other types of background operations. The amount of time for the timeout may depend on the background operation status, which may indicate a specific type of background operation that is currently ongoing. The power down command may be to cause the memory device 404 to enter into a power down mode, a sleep mode, or a deep sleep mode. The power down command may be an SSU command that indicates a power condition value. For example, the host device 402 may transmit the SSU command (e.g., PC=3 or PC=4) to initiate a power down at the memory device 404. Alternatively, the host device 402 may directly transmit the power down command without the command when the background operation status indicates no ongoing background operation at the memory device 404.

As shown by reference number 412, the host device 402 may receive, from the memory device 404, a response. The response may be an ACK. The memory device 404 may transmit the response to acknowledge the power down command. The memory device 404 may disable the background operation prior to transmitting the response, which may help to protect against overcurrent at the memory device 404.

As shown by reference number 414, the host device 402 may instruct, based at least in part on the response, one or more resources associated with the memory device 404 to enter into a low power mode state or an off state. The one or more resources may include one or more power rails or one or more clocks associated with the memory device. The memory device 404 may enter, after the response is transmitted, the low power mode state or the off state for the one or more resources. In other words, a receipt of the response may trigger the one or more resources to be entered into the low power mode state or the off state, and since the background operation has already been disabled, the one or more resources may not enter the low power mode state or the off state while any background operations are still running.

In some aspects, by disabling the background operation before the host device 402 transmits the power down command and before the memory device 404 transmits the response, the memory device 404 may be less likely to draw an amount of power that exceeds a certain threshold after the one or more resources are set to the low power mode state or the off state. The memory device 404 may not draw the amount of power that exceeds the certain threshold because all background operations may be completed at the memory device 404 before the certain threshold is applicable. The certain threshold may be a permissive low power mode current threshold that is enforced only after the one or more resources are set to the low power mode state or the off state. As a result, the memory device 404 may achieve overcurrent protection along with additional power savings. The additional power savings may result from an avoidance of abrupt power downs, which would otherwise cause a greater power drain for the memory device 404.

As indicated above, FIG. 4 is provided as an example. Other examples may differ from what is described with regard to FIG. 4.

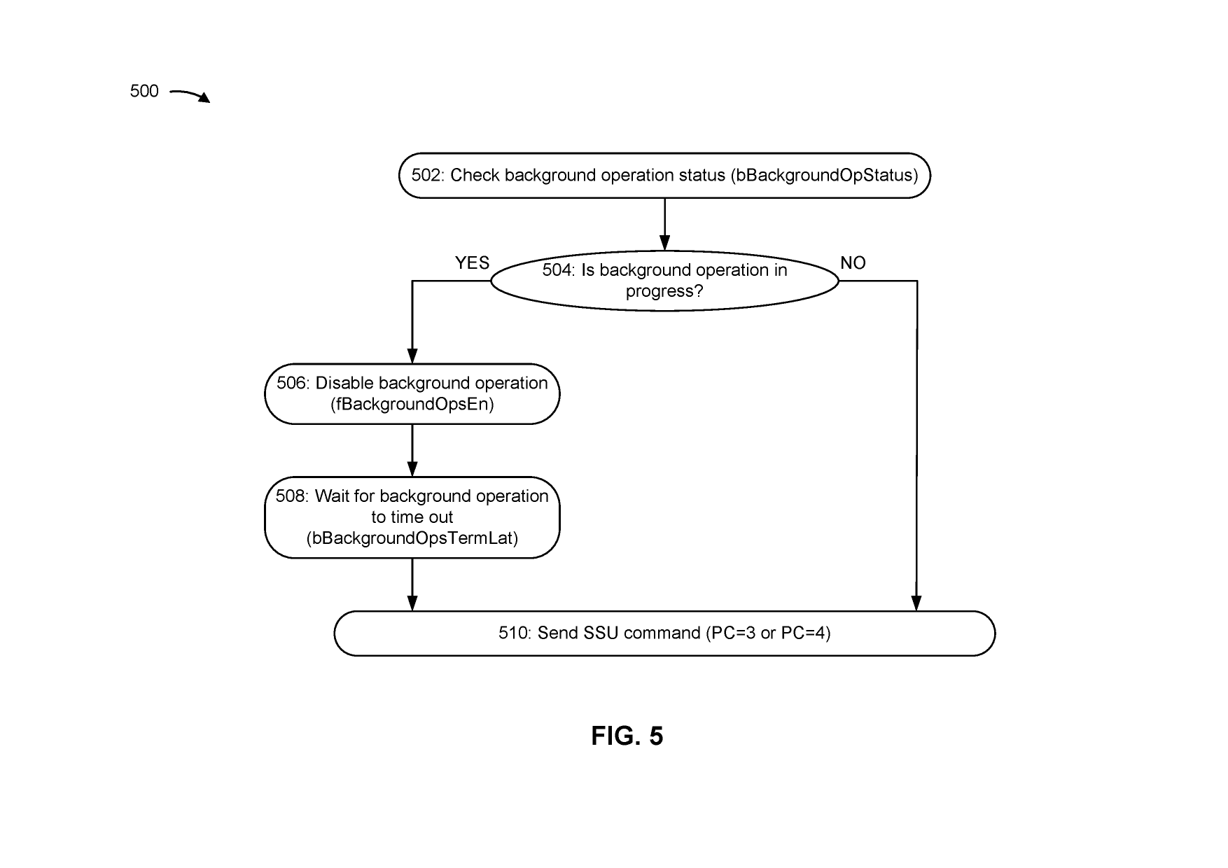

FIG. 5 is a diagram illustrating an example 500 associated with powering down a memory device based at least in part on disabling a background operation associated with the memory device, in accordance with the present disclosure.

As shown by reference number 502, a host device (e.g., host device 402) may check a background operation status (bBackgroundOpStatus) associated with a memory device (e.g., memory device 404). As shown by reference number 504, the host device may determine whether a background operation is in progress for the memory device, which may be based at least in part on the background operation status. As shown by reference number 506, when the background operation is in progress, the host device may disable the background operation (fBackgroundOpsEn). As shown by reference number 508, the host device may wait for the background operation to timeout (bBackgroundOpsTermLat). As shown by reference number 510, the host device may transmit an SSU command to the memory device after the background operation times out, which may ensure that the background operation is no longer ongoing when the memory device receives the SSU command. Alternatively, when the background operation is not in progress, the host device may directly transmit the SSU command (e.g., without disabling the background operation and waiting for the background operation to timeout).

As indicated above, FIG. 5 is provided as an example. Other examples may differ from what is described with regard to FIG. 5.

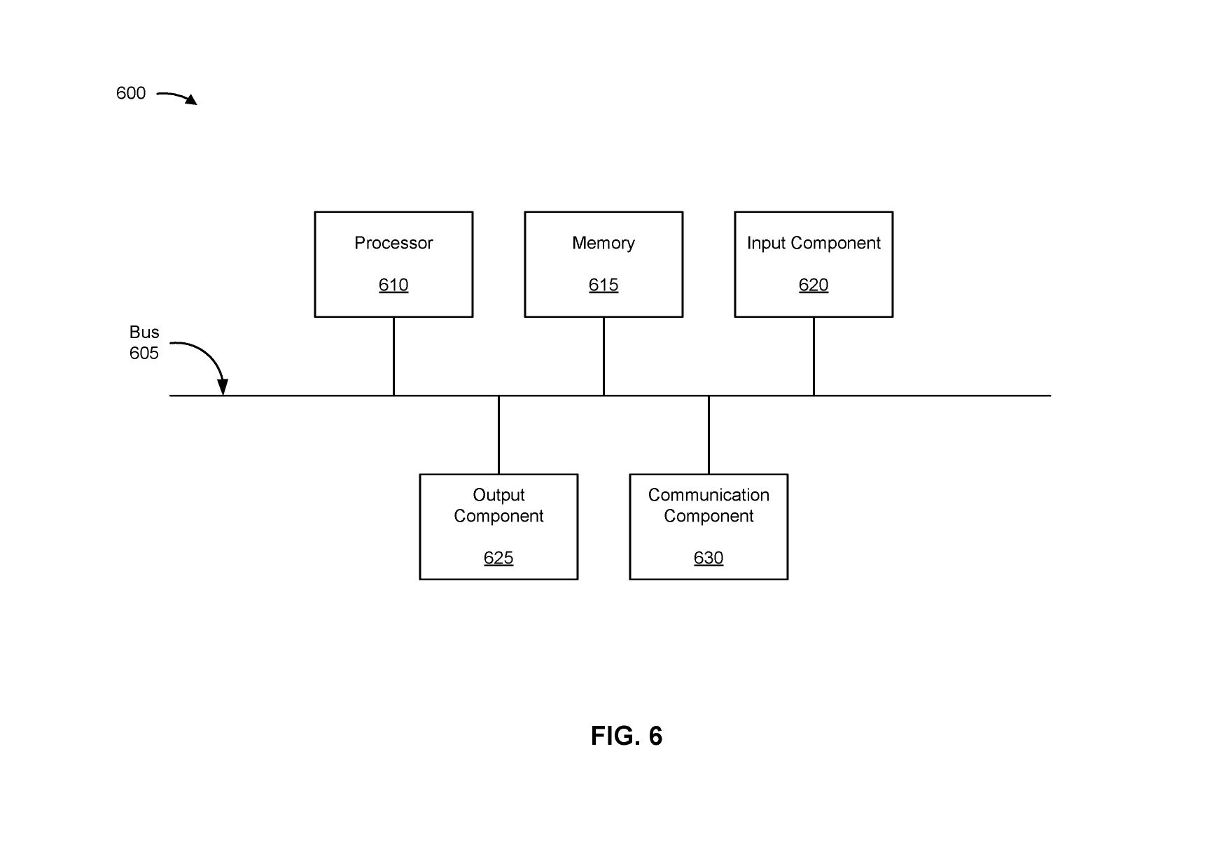

FIG. 6 is a diagram illustrating example components of a device 600, in accordance with the present disclosure. The device 600 may be associated with a device (e.g., host device 402 or memory device 404). As shown in FIG. 6, the device 600 may include a bus 605, a processor 610, a memory 615, an input component 620, an output component 625, and/or a communication component 630.

The bus 605 may include one or more components that enable wired and/or wireless communication among the components of the device 600. The bus 605 may couple together two or more components of FIG. 6, such as via operative coupling, communicative coupling, electronic coupling, and/or electric coupling. For example, the bus 605 may include an electrical connection (e.g., a wire, a trace, and/or a lead) and/or a wireless bus. The processor 610 may include a central processing unit, a graphics processing unit, a microprocessor, a controller, a microcontroller, a digital signal processor, a field-programmable gate array, an application-specific integrated circuit, and/or another type of processing component. The processor 610 may be implemented in hardware, firmware, or a combination of hardware and software. In some aspects, the processor 610 may include one or more processors capable of being programmed to perform one or more operations or processes described elsewhere herein.

The memory 615 may include volatile and/or nonvolatile memory. For example, the memory 615 may include random access memory (RAM), read only memory (ROM), a hard disk drive, and/or another type of memory (e.g., a flash memory, a magnetic memory, and/or an optical memory). The memory 615 may include internal memory (e.g., RAM, ROM, or a hard disk drive) and/or removable memory (e.g., removable via a universal serial bus connection). The memory 615 may be a non-transitory computer-readable medium. The memory 615 may store information, one or more instructions, and/or software (e.g., one or more software applications) related to the operation of the device 600. In some aspects, the memory 615 may include one or more memories that are coupled (e.g., communicatively coupled) to one or more processors (e.g., processor 610), such as via the bus 605. Communicative coupling between a processor 610 and a memory 615 may enable the processor 610 to read and/or process information stored in the memory 615 and/or to store information in the memory 615.

The input component 620 may enable the device 600 to receive input, such as user input and/or sensed input. For example, the input component 620 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 625 may enable the device 600 to provide output, such as via a display, a speaker, and/or a light-emitting diode. The communication component 630 may enable the device 600 to communicate with other devices via a wired connection and/or a wireless connection. For example, the communication component 630 may include a receiver, a transmitter, a transceiver, a modem, a network interface card, and/or an antenna.

The device 600 may perform one or more operations or processes described herein. For example, a non-transitory computer-readable medium (e.g., memory 615) may store a set of instructions (e.g., one or more instructions or code) for execution by the processor 610. The processor 610 may execute the set of instructions to perform one or more operations or processes described herein. In some aspects, execution of the set of instructions, by one or more processors 610, causes the one or more processors 610 and/or the device 600 to perform one or more operations or processes described herein. In some aspects, hardwired circuitry may be used instead of or in combination with the instructions to perform one or more operations or processes described herein. Additionally, or alternatively, the processor 610 may be configured to perform one or more operations or processes described herein. Thus, aspects described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

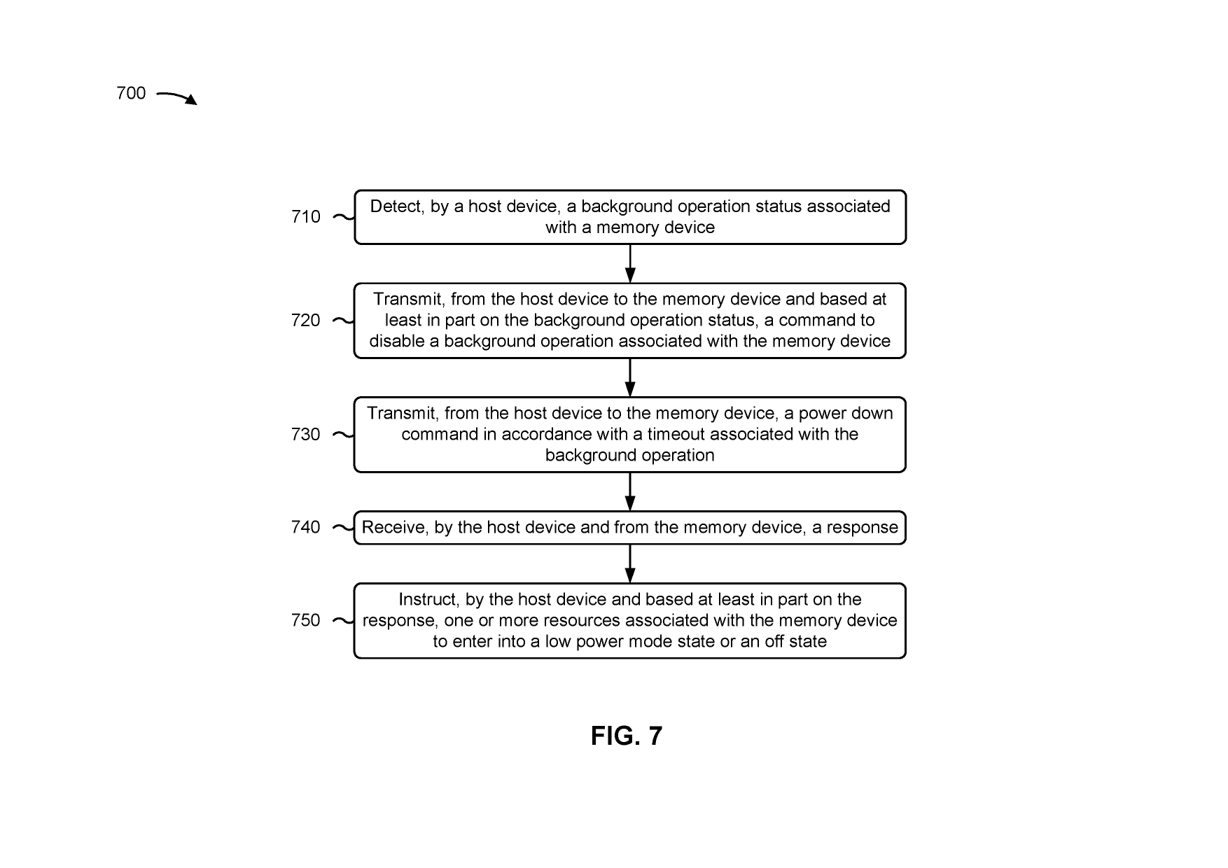

FIG. 7 is a flowchart of an example process 700 associated with powering down a memory device based at least in part on disabling a background operation associated with the memory device, in accordance with the present disclosure. In some implementations, one or more process blocks of FIG. 7 are performed by a host device (e.g., host device 402). Additionally, or alternatively, one or more process blocks of FIG. 7 may be performed by one or more components of device 600, such as processor 610, memory 615, input component 620, output component 625, and/or communication component 630.

As shown in FIG. 7, process 700 may include detecting, by the host device, a background operation status associated with a memory device (block 710). For example, the host device may detect a background operation status associated with a memory device, as described above.

As further shown in FIG. 7, process 700 may include transmitting, from the host device to the memory device and based at least in part on the background operation status, a command to disable a background operation associated with the memory device (block 720). For example, the host device may transmit, to the memory device and based at least in part on the background operation status, a command to disable a background operation associated with the memory device, as described above.

As further shown in FIG. 7, process 700 may include transmitting, from the host device to the memory device, a power down command in accordance with a timeout associated with the background operation (block 730). For example, the host device may transmit, to the memory device, a power down command in accordance with a timeout associated with the background operation, as described above.

As further shown in FIG. 7, process 700 may include receiving, by the host device and from the memory device, a response (block 740). For example, the host device may receive, from the memory device, a response, as described above.

As further shown in FIG. 7, process 700 may include instructing, by the host device and based at least in part on the response, one or more resources associated with the memory device to enter into a low power mode state or an off state (block 750). For example, the host device may instruct, based at least in part on the response, one or more resources associated with the memory device to enter into a low power mode state or an off state, as described above.

Process 700 may include additional implementations, such as any single implementation or any combination of implementations described below and/or in connection with one or more other processes described elsewhere herein.

In a first implementation, process 700 includes transmitting the power down command after waiting for the timeout associated with the background operation.

In a second implementation, alone or in combination with the first implementation, the one or more resources includes one or more power rails or one or more clocks associated with the memory device.

In a third implementation, alone or in combination with one or more of the first and second implementations, the power down command is transmitted without the command when the background operation status indicates no ongoing background operation at the memory device.

In a fourth implementation, alone or in combination with one or more of the first through third implementations, the power down command is to cause the memory device to enter into one of: a power down mode, a sleep mode, or a deep sleep mode.

In a fifth implementation, alone or in combination with one or more of the first through fourth implementations, the power down command is an SSU command that indicates a power condition value.

In a sixth implementation, alone or in combination with one or more of the first through fifth implementations, the host device is a UFS host and the memory device is a UFS device.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

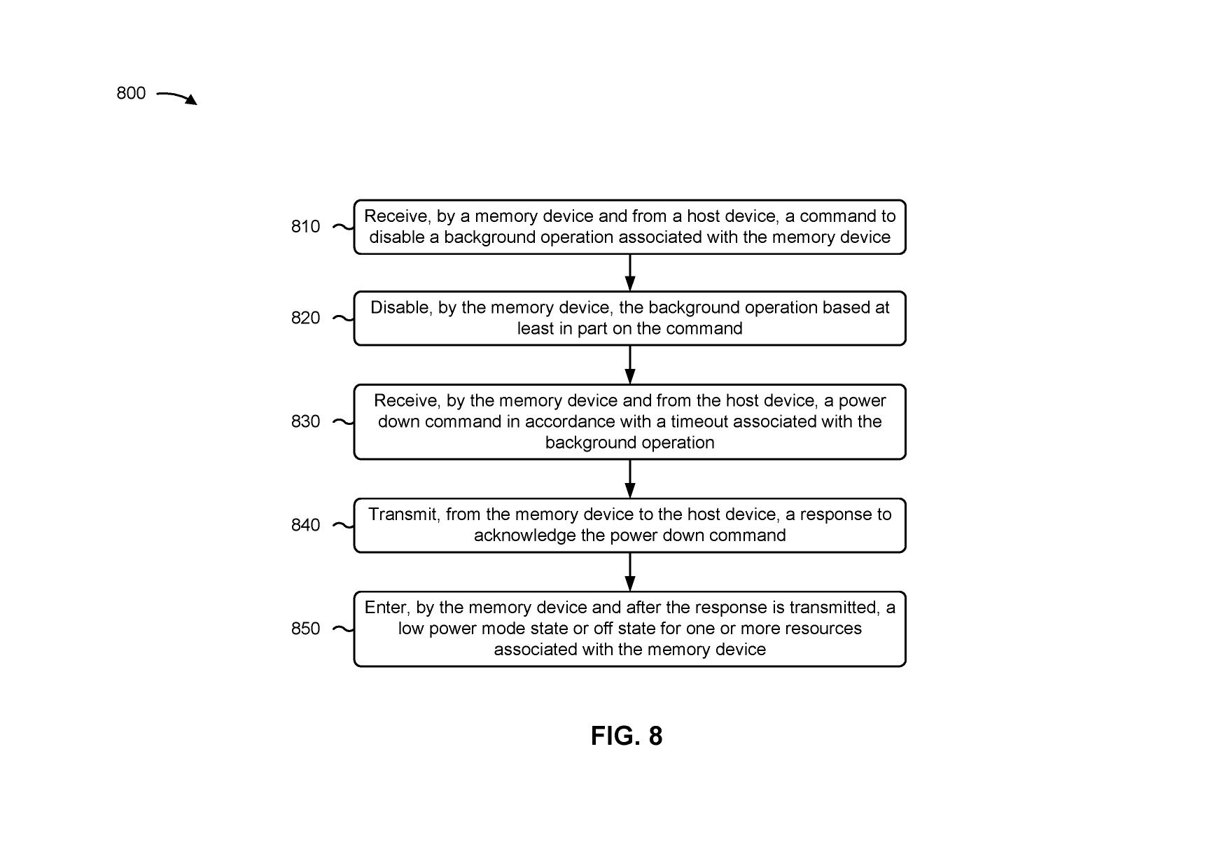

FIG. 8 is a flowchart of an example process 800 associated with powering down a memory device based at least in part on disabling a background operation associated with the memory device, in accordance with the present disclosure. In some implementations, one or more process blocks of FIG. 8 are performed by a memory device (e.g., memory device 404). Additionally, or alternatively, one or more process blocks of FIG. 8 may be performed by one or more components of device 600, such as processor 610, memory 615, input component 620, output component 625, and/or communication component 630.

As shown in FIG. 8, process 800 may include receiving, by the memory device and from a host device, a command to disable a background operation associated with the memory device (block 810). For example, the memory device may receive, from a host device, a command to disable a background operation associated with the memory device, as described above.

As further shown in FIG. 8, process 800 may include disabling, by the memory device, the background operation based at least in part on the command (block 820). For example, the memory device may disable the background operation based at least in part on the command, as described above.

As further shown in FIG. 8, process 800 may include receiving, by the memory device and from the host device, a power down command in accordance with a timeout associated with the background operation (block 830). For example, the memory device may receive, from the host device, a power down command in accordance with a timeout associated with the background operation, as described above.

As further shown in FIG. 8, process 800 may include transmitting, from the memory device to the host device, a response to acknowledge the power down command (block 840). For example, the memory device may transmit, to the host device, a response to acknowledge the power down command, as described above.

As further shown in FIG. 8, process 800 may include entering, by the memory device and after the response is transmitted, a low power mode state or an off state for one or more resources associated with the memory device (block 850). For example, the memory device may enter, after the response is transmitted, a low power mode state or an off state for one or more resources associated with the memory device, as described above.

Process 800 may include additional implementations, such as any single implementation or any combination of implementations described below and/or in connection with one or more other processes described elsewhere herein.

In a first implementation, process 800 includes receiving the command based at least in part on a background operation status associated with the memory device.

In a second implementation, alone or in combination with the first implementation, the power down command is to cause the memory device to enter into one of: a power down mode, a sleep mode, or a deep sleep mode.

In a third implementation, alone or in combination with one or more of the first and second implementations, the one or more resources includes one or more power rails or one or more clocks associated with the memory device.

In a fourth implementation, alone or in combination with one or more of the first through third implementations, the background operation is disabled prior to the response being transmitted to protect against overcurrent at the memory device.

In a fifth implementation, alone or in combination with one or more of the first through fourth implementations, the memory device is a non-volatile memory device.

In a sixth implementation, alone or in combination with one or more of the first through fifth implementations, the host device is a UFS host and the memory device is a UFS device.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The following provides an overview of some Aspects of the present disclosure:

Aspect 1: A host device, comprising: one or more components configured to: detect a background operation status associated with a memory device; transmit, to the memory device and based at least in part on the background operation status, a command to disable a background operation associated with the memory device; transmit, to the memory device, a power down command in accordance with a timeout associated with the background operation; receive, from the memory device, a response; and instruct, based at least in part on the response, one or more resources associated with the memory device to enter into a low power mode state or an off state.

Aspect 2: The host device of Aspect 1, wherein the one or more components are configured to: transmit the power down command after waiting for the timeout associated with the background operation.

Aspect 3: The host device of any of Aspects 1-2, wherein the one or more resources includes one or more power rails or one or more clocks associated with the memory device.

Aspect 4: The host device of any of Aspects 1-3, wherein the power down command is transmitted without the command when the background operation status indicates no ongoing background operation at the memory device.

Aspect 5: The host device of any of Aspects 1-4, wherein the power down command is to cause the memory device to enter into one of: a power down mode, a sleep mode, or a deep sleep mode.

Aspect 6: The host device of any of Aspects 1-5, wherein the power down command is a start stop unit (SSU) command that indicates a power condition value.

Aspect 7: The host device of any of Aspects 1-6, wherein the host device is a universal flash storage (UFS) host and the memory device is a UFS device.

Aspect 8: A memory device, comprising: one or more components configured to: receive, from a host device, a command to disable a background operation associated with the memory device; disable the background operation based at least in part on the command; receive, from the host device, a power down command in accordance with a timeout associated with the background operation; transmit, to the host device, a response to acknowledge the power down command; and enter, after the response is transmitted, a low power mode state or an off state for one or more resources associated with the memory device.

Aspect 9: The memory device of Aspect 8, wherein the one or more components are configured to: receive the command based at least in part on a background operation status associated with the memory device.

Aspect 10: The memory device of any of Aspects 8-9, wherein the power down command is to cause the memory device to enter into one of: a power down mode, a sleep mode, or a deep sleep mode.

Aspect 11: The memory device of any of Aspects 8-10, wherein the one or more resources includes one or more power rails or one or more clocks associated with the memory device.

Aspect 12: The memory device of any of Aspects 8-11, wherein the background operation is disabled prior to the response being transmitted to protect against overcurrent at the memory device.

Aspect 13: The memory device of any of Aspects 8-12, wherein the memory device is a non-volatile memory device.

Aspect 14: The memory device of any of Aspects 8-13, wherein the host device is a universal flash storage (UFS) host and the memory device is a UFS device.

Aspect 15: A method, comprising: detecting, by a host device, a background operation status associated with a memory device; transmitting, from the host device to the memory device and based at least in part on the background operation status, a command to disable a background operation associated with the memory device; transmitting, from the host device to the memory device, a power down command in accordance with a timeout associated with the background operation; receiving, by the host device and from the memory device, a response; and instructing, by the host device and based at least in part on the response, one or more resources associated with the memory device to enter into a low power mode state or an off state.

Aspect 16: The method of Aspect 15, further comprising: transmitting the power down command after waiting for the timeout associated with the background operation.

Aspect 17: The method of any of Aspects 15-16, wherein the one or more resources includes one or more power rails or one or more clocks associated with the memory device.

Aspect 18: The method of any of Aspects 15-17, wherein the power down command is transmitted without the command when the background operation status indicates no ongoing background operation at the memory device.

Aspect 19: The method of any of Aspects 15-18, wherein the power down command is to cause the memory device to enter into one of: a power down mode, a sleep mode, or a deep sleep mode.

Aspect 20: The method of any of Aspects 15-19, wherein the power down command is a start stop unit (SSU) command that indicates a power condition value.

Aspect 21: The method of any of Aspects 15-20, wherein the host device is a universal flash storage (UFS) host and the memory device is a UFS device.

Aspect 22: A method, comprising: receiving, by a memory device and from a host device, a command to disable a background operation associated with the memory device; disabling, by the memory device, the background operation based at least in part on the command; receiving, by the memory device and from the host device, a power down command in accordance with a timeout associated with the background operation; transmitting, from the memory device to the host device, a response to acknowledge the power down command; and entering, by the memory device and after the response is transmitted, a low power mode state or an off state for one or more resources associated with the memory device.

Aspect 23: The method of Aspect 22, further comprising: receiving the command based at least in part on a background operation status associated with the memory device.

Aspect 24: The method of any of Aspects 22-23, wherein the power down command is to cause the memory device to enter into one of: a power down mode, a sleep mode, or a deep sleep mode.

Aspect 25: The method of any of Aspects 22-24, wherein the one or more resources includes one or more power rails or one or more clocks associated with the memory device.

Aspect 26: The method of any of Aspects 22-25, wherein the background operation is disabled prior to the response being transmitted to protect against overcurrent at the memory device.

Aspect 27: The method of any of Aspects 22-26, wherein the memory device is a non-volatile memory device.

Aspect 28: The method of any of Aspects 22-27, wherein the host device is a universal flash storage (UFS) host and the memory device is a UFS device.

Aspect 29: A system, comprising: a host device and a memory device, wherein the host device is configured to: detect a background operation status associated with the memory device; transmit, to the memory device and based at least in part on the background operation status, a command to disable a background operation associated with the memory device; transmit, to the memory device, a power down command in accordance with a timeout associated with the background operation; receive, from the memory device, a response; and instruct, based at least in part on the response, one or more resources associated with the memory device to enter into a low power mode state or an off state; and wherein the memory device is configured to: receive, from the host device, the command to disable the background operation associated with the memory device; disable the background operation based at least in part on the command; receive, from the host device, the power down command in accordance with the timeout associated with the background operation; transmit, to the host device, the response to acknowledge the power down command; and enter, after the response is transmitted, the low power mode state or the off state for one or more resources associated with the memory device.

A system configured to perform one or more operations recited in one or more of Aspects 1-29.

Aspect 30: An apparatus comprising means for performing one or more operations recited in one or more of Aspects 1-29.

Aspect 31: A non-transitory computer-readable medium storing a set of instructions, the set of instructions comprising one or more instructions that, when executed by a device, cause the device to perform one or more operations recited in one or more of Aspects 1-29.

Aspect 32: A computer program product comprising instructions or code for executing one or more operations recited in one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A host device, comprising:
one or more components configured to:
detect a background operation status associated with a memory device;
transmit, to the memory device and based at least in part on the background operation status, a command to disable a background operation associated with the memory device;
transmit, to the memory device, a power down command in accordance with a timeout associated with the background operation;
receive, from the memory device, a response; and
instruct, based at least in part on the response, one or more resources associated with the memory device to enter into a low power mode state or an off state.

2. The host device of claim 1, wherein the one or more components are configured to:
transmit the power down command after waiting for the timeout associated with the background operation.

3. The host device of claim 1, wherein the one or more resources includes one or more power rails or one or more clocks associated with the memory device.

4. The host device of claim 1, wherein the one or more components are configured to:
transmit the power down command without the command when the background operation status indicates no ongoing background operation at the memory device.

5. The host device of claim 1, wherein the power down command is to cause the memory device to enter into one of: a power down mode, a sleep mode, or a deep sleep mode.

6. The host device of claim 1, wherein the power down command is a start stop unit (SSU) command that indicates a power condition value.

7. The host device of claim 1, wherein the host device is a universal flash storage (UFS) host and the memory device is a UFS device.

8. A memory device, comprising:
one or more components configured to:
receive, from a host device, a command to disable a background operation associated with the memory device;
disable the background operation based at least in part on the command;
receive, from the host device, a power down command in accordance with a timeout associated with the background operation;
transmit, to the host device, a response to acknowledge the power down command; and
enter, after the response is transmitted, a low power mode state or an off state for one or more resources associated with the memory device.

9. The memory device of claim 8, wherein the one or more components are configured to:
receive the command based at least in part on a background operation status associated with the memory device.

10. The memory device of claim 8, wherein the power down command is to cause the memory device to enter into one of: a power down mode, a sleep mode, or a deep sleep mode.

11. The memory device of claim 8, wherein the one or more resources includes one or more power rails or one or more clocks associated with the memory device.

12. The memory device of claim 8, wherein the one or more components are configured to:
disable the background operation prior to the response being transmitted to protect against overcurrent at the memory device.

13. The memory device of claim 8, wherein the memory device is a non-volatile memory device.

14. The memory device of claim 8, wherein the host device is a universal flash storage (UFS) host and the memory device is a UFS device.

15. A method, comprising:
detecting, by a host device, a background operation status associated with a memory device;
transmitting, from the host device to the memory device and based at least in part on the background operation status, a command to disable a background operation associated with the memory device;
transmitting, from the host device to the memory device, a power down command in accordance with a timeout associated with the background operation;
receiving, by the host device and from the memory device, a response; and
instructing, by the host device and based at least in part on the response, one or more resources associated with the memory device to enter into a low power mode state or an off state.

16. The method of claim 15, further comprising:
transmitting the power down command after waiting for the timeout associated with the background operation.

17. The method of claim 15, wherein the one or more resources includes one or more power rails or one or more clocks associated with the memory device.

18. The method of claim 15, wherein the power down command is transmitted without the command when the background operation status indicates no ongoing background operation at the memory device.

19. The method of claim 15, wherein the power down command is to cause the memory device to enter into one of: a power down mode, a sleep mode, or a deep sleep mode, and wherein the power down command is a start stop unit (SSU) command that indicates a power condition value.

20. The method of claim 15, wherein the host device is a universal flash storage (UFS) host and the memory device is a UFS device.
